(19) United States
(12) Patent Application Publication
(10) Pub. No.: US 2009/0142055 A1
(43) Pub. Date: Jun. 4, 2009

(54) Control device and a method for controlling an optical data transmission, and a shared storage network system

(75) Inventors: Qiang Qiu, Singapore (SG); Jit Biswas, Singapore (SG)

Correspondence Address: FOLEY AND LARDNER LLP;SUITE 500, 3000 K STREET NW, WASHINGTON, DC, 20007, US

(73) Assignee: AGENCY FOR SCIENCE, TECHNOLOGY AND RESEARCH

(21) Appl. No.: 10/585,577

(22) PCT Filed: Jan. 8, 2004
(86) PCT No.: PCT/SG04/00008

§ 371 Date: Nov. 6, 2006

(51) Int. Cl. H04J 14/00

(52) U.S. Cl. 398/45

(57) ABSTRACT

A control device for controlling the optical data transmission in an optical burst switching mode between a source computer and a destination computer, the control device being connected to the source computer and to the destination computer and being adapted such that in case of a burst to be transmitted from the source computer to the destination computer, the length of the burst is determined based on a parameter indicating an available buffer size of the destination computer, and a predetermined timeout value parameter indicating a time after which improper burst transmission is assumed to have been occurred. After the burst length is determined and the traffic starts to be accumulated, a proposed burst reservation and transmission scheme, namely random burst eligibility time method, is used to deliver the burst.

### BACKGROUND OF THE INVENTION

1. Field of the Invention

The present invention relates to a control device and a method for controlling the optical data transmission in an optical burst switching mode between a source computer and a destination computer, and relates to a shared storage network system.

2. Description of the Related Art

The improvement of computer storage devices, e.g. hard disk, and of computer storage management is a main issue in the development of computer technology.

Considering the trend of rapidly growing data volumes and increasing scattered organization, shared storage has be highly valued as a powerful concept for storage systems to offer scale, flexibility, availability and some other attributes. A key enabling technology for shared storage is networking technology that can provide high bandwidth, large scale, good connectivity and long-distance connectivity at a cost that makes shared storage an attractive alternative to the historical host-attached storage model.

Fiber-channel based Storage Area Networks (SANs) are optimized for high-volume block-oriented data transfer in local area. However, since fiber channel is an inherently local communication technology, fiber-channel based Storage Area Networks cannot really go wide-area. A current solution of a high-volume block-oriented shared storage system over a long distance is usually implemented to connect two isolated SANs using DWDM (dense wavelength dimension multiplex). DWDM is using optical circuit switching. A dedicated circuit (wavelength) needs to be allocated between two end-points for connection-oriented communication. Such solution performs well for the continuous read/write operations with large packet size, which could occur in the case such as data backup and disaster recovery.

However, when a particular scientific computing application, e.g. a Bio-Informatics application, wants to access the data located at such a shared storage over a long distance, there may be a loop running in this application. At the beginning of such a loop, a chunk of data is fetched from the storage, and after the computing is performed, another chunk of data reflecting the result is written back. Because of the huge bandwidth available in the optical domain, e.g. 10 G (Gigabit/s) or 40 G, the I/O traffic generated by such application will appear in the optical channel to be discontinuous, having a very short duration and may be regular pattern. That is, a dedicated circuit is held but be left idle for most of the time.

In the prior art optical networks switching is implemented in optical networks connecting a plurality of computers. Currently, three switching techniques are used in the prior art for optical networks.

A first one is the optical circuit switch, which provides a dedicated circuit (wavelength) between two end-points for connection-oriented communication.

With a second one, the optical packet switch, each optical packet, which is appended with the routing information, is transmitted along a route that is calculated in each hop according to the information within the optical packet.

A third technique is the optical burst switch method which can improve the poor resource utilization of the optical circuit switch by statistically multiplexing data bursts and simultaneously, the optical burst switch method can attenuate the technical limitations of the optical packet switch.

In the following, an optical burst switch system 100 according to the prior art is described with reference to FIG. 1.

The optical burst switch system 100 is adapted to generate a data output 102 from a data input 101, by using the functionality of a switch matrix 103. Beyond this, the input data 101 are passed through an arrangement of an input module 104, a control packet routing unit 105, a buffer and schedule unit 106 exchanging control signals with the switch matrix 103, and an output module 107.

The current use of a circuit switching mechanism is relatively simple to realize but requires a certain amount of time for channel establishment and release independent of the connection holding time. This overhead, mainly determined by the end-to-end signalling time, leads to poor channel utilization if connection holding times are very short. The pressure to optimize network resources and protocols for IP (internet protocol) traffic has focussed attention on network architectures that can rapidly adapt to changes in traffic patterns as well as traffic loads.

Optical packet switching allows good bandwidth utilization, latency, and adaptability in the optical domain. However presently, optical packet switching is difficult to implement due to the lack of optical random access memory (RAM) and other necessary signal processing capability.

Optical burst switching is attracting the spotlight because it comprises IP over WDM (wavelength division multiplex) circuit switching and pure optical packet switching with limited use of optical buffers. In optical burst switching (OBS) technology, burst data can be transported without optical RAMs at intermediate nodes. In OBS technology, a data burst cuts through intermediate nodes without being buffered, whereas in packet switching, a packet is stored and forwarded at each intermediate node. Compared to optical circuit switching, OBS technology can achieve better bandwidth utilization because it allows statistical sharing of each wavelength among the flow of bursts that may otherwise consume several wavelengths. In addition, a burst will have a shorter end-to-end delay since the offset time used in OBS technology is often much shorter than the time needed to set up a wavelength path in wavelength routed networks.

According to the prior art, various burst switching techniques have been proposed: Tell-and-go (TAG), in-band-terminator (IBT) and reserve-a-fixed-duration (RFD), and so on. The TAG technique is similar to fast circuit switching. It transmits data bursts without an acknowledgement that bandwidth has been successfully reserved for the entire circuit. An IBT scheme reserves the bandwidth from the time the control packet is processed to the time the IBT is detected. In burst switching based on RFD, bandwidth is reserved for a duration specified by each control packet which eliminates signalling overhead and offer efficient bandwidth reservation, see [6].

Just-Enough-Time (JET) is an RFD-based burst switching protocol in the optical domain. It adopts two unique characteristics, namely, the use of offset time and delayed reservation. These features make JET and its variations more suitable for OBS than OBS protocols based on TAG or other one way reservation schemes that do not adopt either or both of these features, see [4]. JET allows switching of data channels entirely in the optical domain by processing control packets in the electronic domain. A control packet precedes every data burst. Both the control packet and the corresponding data burst are separated by an offset time and are launched at the source node. The separate transmission and switching of data bursts and their headers help to facilitate the processing of headers and to lower the optoelectronic processing capacity required at a core node. Moreover, by assigning extra-offset time, JET can be extended to support prioritized services in the optical domain.

FIG. 2 illustrates in a schematic diagram 200 the transmission of a burst 203 from a source computer 205 to a destination computer 206 via intermediate computers 207 according to the JET method known from the prior art.

Along an abscissa 201 of the diagram 200, the path from the source computer 205 to the destination computer 206 is represented. Along an ordinate 202 of the diagram 200, the transmission time is represented.

As one can gather from the signal configuration at the node of source computer 205, the burst 203 is preceded by a control packet 204 containing control information. Burst 203 is delayed compared to control packet 204 by an offset time 208. By said offset time, the delay for processing the control packet 204 is compensated.

The control packet 204 contains information necessary for routing the data burst through the optical channel, as well as information on the length of the burst 203 and the offset value 208.

Another important characteristic of JET, as disclosed by [4], is a delayed reservation which will described in the following referring to a schematic time diagram 300 shown in FIG. 3, wherein the time is shown along a time axis 301.

JET is adapted to reserve the bandwidth on each link just for the data burst duration. For example, let t₁′ be the time when the first control packet 204 arrives at a node after the control packet 204 is processed and the bandwidth is reserved for the period from t₁ (the time the data burst 203 arrives at a node) to t₁+L₁ (the data burst 203 duration). This increases the bandwidth utilization and reduces the probability that a burst 203 will be dropped.

For example, in both cases (case 1 302 and case 2 303) shown in FIG. 3, namely t₂>t₁+L₁ (case 1 302) and t₂<t₁ (case 2 303), the second burst will not be dropped, provided that its length is shorter than t₁−t₂. However, when the second burst using TAG arrives at t₂′, it will be dropped because there is no buffer for it.

A signalling architecture for OBS networks with a different wavelength reservation scheme, referred to as just-in-time (JIT), is disclosed in [5]. A scalable burst switching architecture with a wavelength reservation scheme called Horizon is disclosed in [7]. [8] compares the burst loss probabilities of JET, JIT and Horizon. [9] discloses a different burst switching architecture and a class of wavelength scheduling algorithms. [10] discloses a wavelength scheduling algorithm, and compares it with the wavelength scheduling algorithms disclosed in [9]. [11] describes a priority scheme based on JET for multi-class traffic. In this scheme, higher priority bursts are assigned longer offsets than lower priority bursts. [12] analyzes approximately this priority scheme considering the class interference, and discloses that the burst inter-arrival time distribution has only a small impact on the burst loss probability, while the burst length distribution and the ratio of the mean burst length of the classes have a great impact on the burst loss probability.

[3] is related to the SNIA (Storage Network Industry Association) standard which is a layer architecture for a network system of nodes sharing common memory resources.

### SUMMARY OF THE INVENTION

It is an object of the present invention to provide a control device and a method for controlling an optical data transmission and to provide a shared storage network system with an improved performance and quality of service (QoS) compared to the related art.

The object is achieved by providing a control device and a method for controlling the optical data transmission in an optical burst switching mode between a source computer and a destination computer, and by providing a shared storage network system with the features according to the independent claims.

According to the invention, a control device is provided for controlling the optical data transmission in an optical burst switching mode between a source computer and a destination computer. The control device is connected to the source computer and to the destination computer. Further, the control device is adapted such that in case of a burst to be transmitted from the source computer to the destination computer, the length of the burst is determined based on a parameter indicating an available buffer size of the destination computer, and based on a predetermined timeout value parameter indicating a time after which improper burst transmission is assumed to have been occurred.

Moreover, a shared storage network system is provided by the invention, comprising a control device having the above-described features for controlling the optical data transmission in an optical burst switching mode between one of at least one storage server each providing a storage portion to the shared storage network system and one of at least one storage client adapted to have read and/or write access to at least one storage portion of at least one of the at least one storage server, the storage server and the storage client being the source computer and the destination computer.

Beyond this, a method for controlling the optical data transmission in an optical burst switching mode between a source computer and a destination computer is provided, comprising the step of connecting the source computer to the destination computer. According to a further method step, in case of a burst to be transmitted from the source computer to the destination computer, the length of the burst is determined based on a parameter indicating an available buffer size of the destination computer, and a predetermined timeout value parameter indicating a time after which improper burst transmission is assumed to have been occurred.

A basic idea and a core of the invention can be seen in that the transmission of a burst is controlled based on determining the length of the burst to be transmitted. Early determining said length, i.e. an amount of data to be transmitted from the source computer to the destination computer, before sending the burst along the data path, allows to manage and distribute path resources for bursts to be transmitted in a very efficient manner. According to the invention, two particular parameters are included in said burst length estimation, namely an available buffer size of the destination computer and a predetermined timeout value parameter.

By considering the available buffer size of the destination computer as a parameter for the burst length determination, it can securely be prevented that a burst is transmitted, although the burst length does not meet frame conditions concerning the buffer dimension of the destination computer. By taking this measure, failures during transmission of the burst can be reduced. An overcharge of destination computer capability, resulting from a transmitted data amount which is not compatible with destination computer resources, is thus avoided.

Moreover, the burst length determination is realized under consideration of a predetermined timeout value parameter indicating a time after which improper burst transmission is assumed to have been occurred, e.g. an NAK (negative acknowledgement) is sent. Problems can arise when the dimension of a burst to be transmitted is that huge that before finishing data transfer, the system assumes improper burst transmission, since transmission time exceeds a preset threshold. By taking such a timeout value into account, improper transmission of a burst is reduced yielding a better performance for transmitting bursts and a more efficient usage of bandwidth of a data transfer network.

A basic idea of the invention is thus to implement a data flow control to accumulate I/O traffic in an edge node to be a burst with a proper length before the traffic travelling through the network, preferably an optical domain, and then to access the optical channel in a highly sharing way and also with differential service supported.

Another key aspect of the invention is to implement such a control device in a shared storage network system for controlling the transmission of a burst between a storage server functioning as a storage providing node and a storage client functioning as a storage consuming node consuming storage of the storage server via a read and/or write access. Storage portions of a plurality of remote storage servers (i.e. storage providing nodes of the network) mutually form a huge global storage which can be accessed by one or more storage clients (i.e. storage consuming nodes), from a remote position in a global network. The storage server may act as the source computer and the storage client may act as the destination computer during a read access. The storage client may act as the source computer and the storage server may act as the destination computer during a write access. This system allows very easy access from each storage consuming node to each storage or memory portion of each storage providing node. Thus, common storage resources can be shared very efficiently, since burst length control associated with a data transmission between storage server and storage client is controlled by the control device of the invention. Therefore, data transfer within the shared storage network system of the invention allows a very efficient use and distribution of data transmission resources in the network.

A main idea of the invention can be seen in adaptively determining the burst length in an optical burst flow and then using a burst transmission method provided by the invention to access the optical channel in a highly sharing manner with QoS (quality of service) support. Preferably, the burst length is determined in dependence of a predetermined window size (CWinit), a predetermined packet size (P), a round trip time (R), a peak service rate at a client (u), a parameter indicating an available buffer size of the client size (α) and/or a predetermined timeout value parameter (β).

According to preferred embodiments of the invention, optical burst flow control (OBFC) system and method are taught to enable a network, preferably an optical burst switching (OBS) network, as interconnection network for a large scale shared storage system in WAN (wide area network) or MAN (metropolitan area network) context. Major components of the provided OBFC system and method include a dynamic data burst assembly method and a random burst eligibility time method, which is a burst reservation and transmission method. A globally addressable storage system (shared storage network system) can be designed as a large scale distributed shared storage system with an optical network as interconnection network. The storage client/server nodes in the network are interconnected with each other through optical links. The storage portion of each storage server represents the storage server's contribution to the common storage shared by the storage clients of the shared storage network system. Each storage portion is divided into a plurality of sectors, each sector is divided into a plurality of blocks, a virtual block identifier being associated to each of the blocks such that the entirety of all of the virtual block identifiers of the blocks form a global block address space in which each of the virtual block identifiers is unique. Thus, each block in the system is globally identified by a global block address. The OBFC method introduced greatly increases optical network utilization and makes it suitable as the interconnection network to support the high bandwidth demand and scalable Quality of Service (QoS) requirement of a large scale distributed shared storage system.

Thus, the system is designed to provide a better end-to-end solution for high-volume block-oriented data sharing over a large scale of distribute networks by increasing the utilization and the sharing level greatly in the optical domain.

In order to efficiently utilize the huge bandwidth in the optical domain, the OBFC method is provided to enable the flexible sharing and high utilization of the optical channel for the I/O generated traffic to support a high-volume block-oriented shared storage over large scale network. Major components of the method include one dynamic burst assembly mechanism and one burst reservation and transmission method. As burst reservation and transmission method, a random burst eligibility time method can be implemented. A basic idea of this method is to use the flow control to accumulate the I/O traffic in the edge node to be a burst with a proper length before the traffic travelling through the optical domain, and then use the random burst eligibility time method to access the optical channel in a highly sharing way and also with differential service supported.

According to a preferred embodiment, a globally addressable storage network system is provided as a shared storage system with a single storage address space over optical networks. In order to cooperate with the optical network, which could provide nearly unlimited bandwidth, an optical burst flow control method is provided to enable flexible sharing and high utilization of the optical channel to make the optical burst switching (OBS) network suitable as interconnection network for a large scale shared storage system in WAN or MAN context. Major components of the OBFC algorithm include a dynamic burst assembly mechanism and a burst reservation and transmission method denoted as random burst eligibility time method.

After the burst length is determined according to the invention and traffic starts to be accumulated, a burst reservation and transmission scheme provided by the invention, namely random burst eligibility time method, may be used to deliver the burst. The burst length determination is a preparation step to be preferably performed before carrying out a burst transmission method, particularly the so-called random burst eligibility time method.

An important aspect of the invention can be seen in that the flow control is used to accumulate the I/O traffic to be a burst with a proper length before the traffic travelling through the optical domain, and then use a burst reservation and transmission method, namely random burst eligibility time method, to access the optical channel in a highly sharing way and also with differential service supported.

A main idea is that, once the I/O request is granted, a proper length burst starts to be prepared. The proper length of the burst to be accumulated is preferably decided by negotiating the ACK (acknowledgement) window size, based on the parameters contained in the I/O request, such as application require rate, application deadline and so on.

And then, the server preferably will randomly pickup a time between the time to prepare the minimum burst and the time to prepare the full pre-determined burst decided in the burst length determination step as the eligibility time for the burst transmission. Since a high priority application will allow shorter burst to be created, in this way, a high priority request more likely gets shorter response time and lower blocking probability. Low (or lower) priority request gets slower response, but during waiting large traffic could be accumulated. Thus, network utilization can be increased by this fully accumulated burst.

The burst mode transmission is used to improve the utilization and sharing level of the optical data channel However, this method is not limited only to burst traffic situation. It is instead a general optical data transmission method. Also, data channel and control channel are preferably used together to make it work, instead of only data path.

It is noted that the device, the system and the method of the invention each are related to a general optical data transmission scheme instead of concerning only the traffic burst situation.

In the following, further preferred embodiments of the control device of the invention are described.

The control device may be adapted such that the length of the burst is determined further based on an initial window size indicating a number of data packets which the source computer is able to send before waiting for an acknowledgement. By including this parameter in the burst length determination, improper burst transmission due to improper burst length can be avoided with further increased reliability. Including this parameter also considers source computer requirements for determining the length of a burst to be transmitted.

The control device can further be adapted such that the length of the burst is determined further based on a packet size indicating the size of data packets which the source computer is able to send. By including this parameter in the determination of the burst length, another important source computer requirement is taken into account when determining a proper burst length.

According to a preferred embodiment, the control device is adapted such that the length of the burst is determined further based on a round trip time of the burst transmission. Thus, failures during transmission of the burst are further reduced.

The length of the burst can further be determined based on a peak service rate which the destination computer is able to service. This parameter, again, is related to the operating frame conditions of the destination computer.

Moreover, the control device can be adapted such that the length of the burst is determined in dependence of a minimum function depending of the parameter indicating an available buffer size of the destination computer and depending of the predetermined timeout value parameter indicating a time after which improper burst transmission is assumed to have been occurred. This combination of parameters provides a particularly advantageous determination of a proper burst length and allows a particular efficient usage of network data transmission resources.

Preferably, the control device is adapted such that data to be transmitted is accumulated in the source computer until the size of the data to be transmitted generally equals the determined length of the burst to be transmitted. In other words, data is accumulated until the accumulated data size reaches the determined proper burst length. This amount of data then fits with hardware frame conditions of the system so that with this data size a successful burst transmission can likely be achieved.

The control device can be adapted such that, based on the determined length of the burst to be transmitted, resources for transmitting the burst are reserved and the burst is transmitted. Such a reservation ensures that enough resources are free in the network for transmitting the burst. This avoids undesired burst blocking or delay.

The control device may further be adapted such that the reservation and transmission is realized using an optical burst switch network. Thus, the system of the invention can profit of the advantages of an optical burst switch network.

The optical burst switch network may comprise means for sending a control packet followed by the burst after a predetermined offset time. Such a control packet may contain information necessary for routing the data burst through an optical channel, as well as information on the length of the burst and the offset value. By said offset time, a delay for processing the control packet at one or more nodes in the data path can be compensated.

The control device according to the invention can be adapted such that the optical burst switch network comprises means for sending a reservation confirmation packet indicating that reservation has been performed.

As an alternative to the previously described embodiments, the control device can be adapted such that the reservation and transmission is realized by dividing, in the time domain, a burst to be transmitted into a plurality of burst slices.

In case of a predetermined data path for transmission of the burst, at least one intermediate computer located in the data path between the source computer and the destination computer may be implemented as a cache storage computer for temporarily storing data related to the transmitted burst. If data are transmitted along a data path located between the source computer and the destination computer, intermediate computers along said path may provide the functionality of temporarily storing the data to be transmitted. Thus, a loss of data can be avoided in a scenario in which data transmission is not performed properly.

The control device of the invention is preferably adapted such that once the length of the burst is determined, a burst reservation and transmission is performed based on a random burst eligibility time method, to deliver the optical burst. In this context, the control device is further preferably adapted such that a time between the time to prepare a minimum burst and the time to prepare a full pre-determined burst is randomly picked up as a burst eligibility time. According to this configuration, a server will randomly pick up a time between the time to prepare the minimum burst and the time to prepare the full pre-determined burst decided in the burst length determination step as the eligibility time for the burst transmission. Since high priority applications will allow shorter bursts to be created, in this way, high priority requests more likely get shorter response time and lower blocking probability. Low priority requests get slower response but during waiting large traffic could be accumulated. Thus, network utilization is increased by those fully accumulated burst.

The burst length determination on the basis of particular parameters combined with the burst transmission through the random burst eligibility time together allow for a highly efficient data transfer, since these components are adapted to preferably function together as a whole.

Although the above embodiments have been described related to the control device of the inventions, each of these embodiments can also be implemented in the method of the invention for controlling the transmission of a burst, and can also be implemented in the shared storage network system of the invention.

In the following, preferred embodiments of the shared storage system of the invention are described.

According to a preferred embodiment of the shared storage network system, the at least one storage server is located within a first local area network, and the at least one storage client is located within a second local area network, the first local area network and the second local area network being interconnected to form a global network. The at least one storage server and the at least one storage client are interconnected such that in case of a read or a write access of one of the at least one storage client to one of the at least one storage server, the length of a burst to be transmitted according to the read or write access is determined based on the parameter indicating an available buffer size of the storage server or the storage client, which storage server or storage client is the destination computer of the burst transmission associated with the read or write access, and based on the predetermined timeout value parameter indicating a time after which improper burst transmission is assumed to have been occurred.

Further, the first local area network may comprise at least one of said at least storage client and/or the second local area network further may comprise at least one of the at least one storage server. In other words, each of the local area networks (LANs) may comprise one or a plurality of storage servers as storage providing nodes and/or one or a plurality of storage clients as storage consuming nodes.

The shared storage network system can further comprise at least one further local area network comprising at least one storage server and/or at least one storage client, the at least one further local area network being interconnected to the global network. Thus, any desired number of LANs may be included in the shared storage network system of the invention, wherein the larger the number of LANs having storage servers, the larger the amount of shared storage resources.

In the shared storage network system, at least one of the local area networks can comprise a linking computer being interconnected as a link between the at least one storage server and/or the at least one storage client of the local area network associated with the linking computer on the one hand and the remaining local area network or networks on the other hand. Such a linking computer associated to a particular LAN may provide interface services required at the interface between the LAN and the global network. For example, the linking computer can be adapted to perform a translation of a virtual block address of a block to which access is desired into a physical block address of this block. In other words, resources for realizing a local to global address translation may be included in the linking computer.

At least one of the local area networks can be an optical network or a wired network. Particularly, a part of the LANs may be realized as a conventional wired network, whereas another part of the LANs may be realized as an optical network.

The shared storage network system according to the invention may be adapted to operate based on the Storage Networking Industry Association (SNIA) standard. Particularly, an implementation of the system of the invention in the block layer (layer II) of the SNIA shared storage model is advantageous.

In the shared storage network system, the entirety of all of the storage portions of the at least one storage server may form a global block address space, so that each block of a sector of a storage portion of a storage server may be uniquely addressed using a unique global block address associated to a particular block.

The above and other objects, features and advantages of the present invention will become apparent from the following description and the appended claims, taken in conjunction with the accompanying drawings in which like parts or elements are denoted by like reference numbers.

### BRIEF DESCRIPTION OF THE DRAWINGS

The accompanying drawings, which are included to provide a further understanding of the invention and constitute a part of the specification illustrate embodiments of the invention.

In the drawings:

FIG. 1 shows an optical burst switch system according to the prior art,

FIG. 2 is a diagram showing the transmission of a burst according to the JET method known from the prior art,

FIG. 3 shows a time diagram of the transmission of a burst according to the JET method known from the prior art,

FIG. 4 shows schematically the layer structure according to the Storage Networking Industry Association (SNIA) standard,

FIG. 5 shows a shared storage network system according to a preferred embodiment of the invention,

FIG. 6 shows a shared storage network system according to another preferred embodiment of the invention,

FIG. 7 shows a data path illustrating the transmission of a burst according to a preferred embodiment of the invention,

FIG. 8 shows a data path illustrating the transmission of a burst according to another preferred embodiment of the invention.

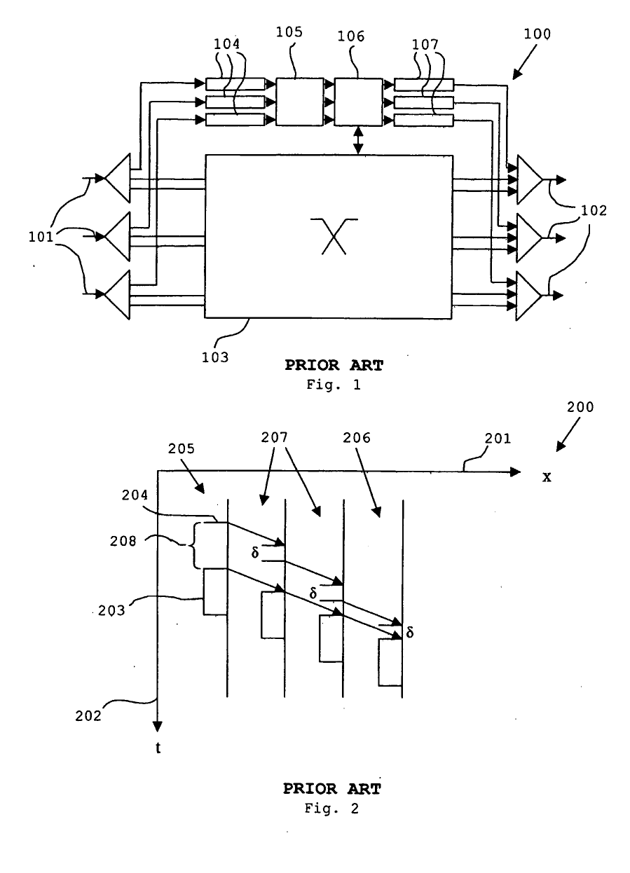

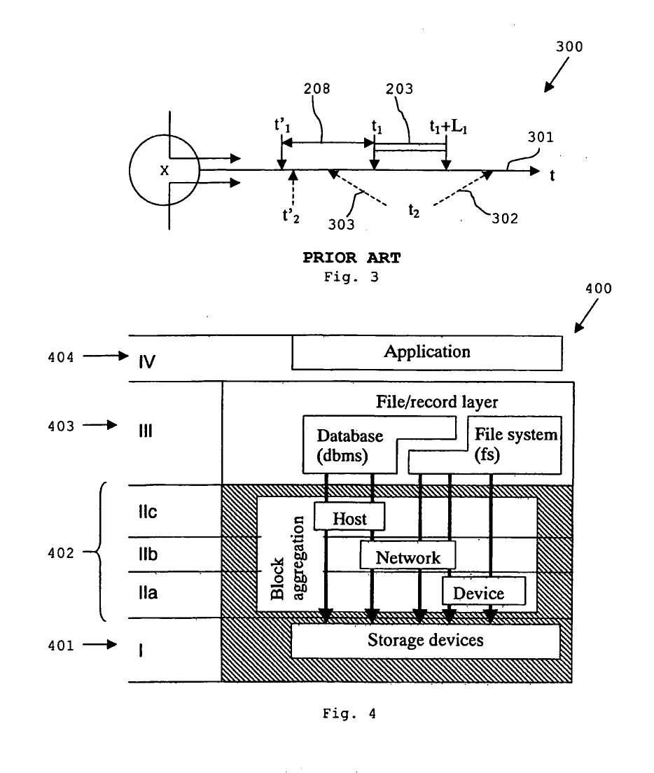

### DETAILED DESCRIPTION OF PREFERRED EMBODIMENTS OF THE INVENTION

In the following, the SNIA (Storage Network Industry Association) standard, which is preferably included in the network architecture of the shared storage network system of the invention, will be described referring to FIG. 4.

Similar to the OSI 7-layer model in conventional networking, the SNIA Shared Storage Model describes common storage architectures. The layer Structure according to the SNIA standard is illustrated in FIG. 4. In other words, the layering scheme of the SNIA Shared Storage Model is visualized in FIG. 4.

According to the SNIA layer model 400 shown in FIG. 4, there is provided a layer I 401 representing the level of storage devices of a storage network. Further, a level II 402 denotes a block layer representing host, network and devices and is thus subdivided into three sublayers IIa, IIb, IIc. Moreover, a layer III 403 is provided as a file/record layer including database and file system and it thus subdivided into two sublayers IIIa, IIIb. Beyond this, a level IV 404 is provided as an application layer.

In the following, layer III 403, the file/record layer, of the SNIA layer model 400 will be described in more detail.

Layer III 403 packs small things such as files (byte vectors) and database tuples (records) into larger entities such as block-level volumes and storage device logical units.

The two common implementations seen at level III 403 are database management systems and file systems. Both provide mechanisms for naming or indexing files or records, enforcing access controls, performing space allocation and clustering, and caching data for rapid access. In both cases, the file/record layer is located on top of one or more volumes: large block-vector stores or byte-vectors provided by an underlying block store or (sometimes) file system.

The functions provided by the file/record layer can be implemented in several different places:
solely in the host: these are the traditional host-based file systems and databases. In such systems, the implementation of the file system or database resides completely in the host, and the interface to the storage device is at the block-vector level.
in both client and server: these are the standard “network” file systems such as NFS (Network File System), CIFS (Common Internet File System), etc. Such implementations split their functions between the client (host) and the server system.

In the following, layer II 402, namely the block layer, of the SNIA layer model 400 will be described.

The block layer provides low-level storage to higher layers, typically with an access interface that supports one or more linear vectors of fixed-size blocks.

Ultimately, data is stored on “native” storage devices such as disk drives, solid-state disks, and tape drives. These devices can be used directly, or the storage they provide can be aggregated into one or more block vectors to increase or decrease their size, or provide redundancy.

Secondary responsibilities of the block layer include a simple form of naming, such as SCSI Logical Unit Names (LUNs), caching (and, in particular, non-volatile caches for write-behind data), and (increasingly) simple access control.

Block aggregation comprises a powerful set of techniques that are used to serve many purposes. These include:
space management: constructing a large block vector by assembling several smaller ones, or packing many small block vectors into one large one, or both.
striping: apportioning load across several lower-level block vectors and the systems that provide them. The typical reason for doing this is to increase throughput by increasing the amount of parallelism available; a valuable secondary benefit may be the reduction in average latency that can result as a side effect.

Providing redundancy for increasing availability in the face of storage device failures. This can be full redundancy (e.g., local & remote mirroring, RAID-1, -10 . . . ), or partial redundancy (RAID-3, -4, -5, . . . ). Additional features like point-in-time copy can be provided, which can be used to increase the effective redundancy level of a system, and to assist recovery from other kinds of failures.

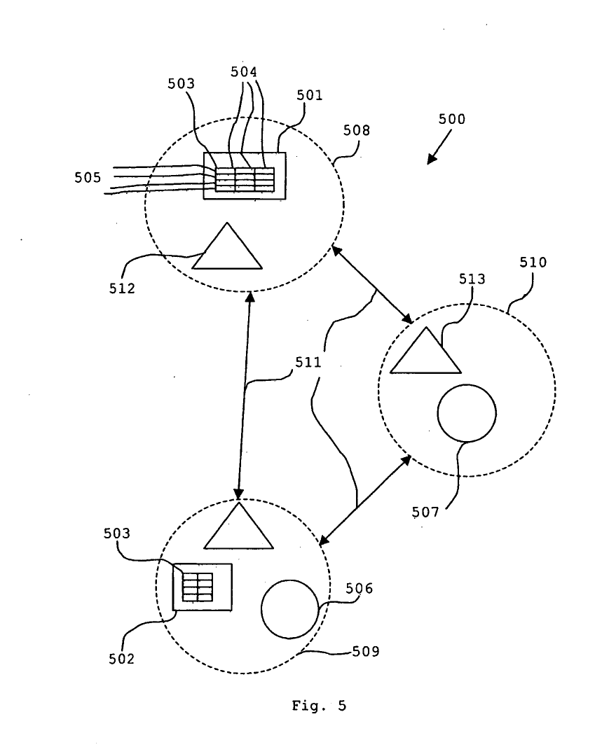

Referring to FIG. 5, a shared storage network system 500 according to a preferred embodiment of the invention will be explained.

The shared storage network system 500 comprises a first storage server 501 and a second storage server 502 functioning as storage providing nodes, each providing a storage portion 503 of the shared storage network system 500. Each storage portion 503 of the first storage server 501 and of the second storage server 502 is divided into a plurality of sectors 504 (shown in FIG. 5 schematically as columns of a matrix), each sector 205 being divided into a plurality of blocks 505 (shown in FIG. 5 schematically as elements of the matrix at each intersection of a matrix column and a matrix row). A virtual block identifier is associated to each of the blocks 505 such that the entirety of all of the virtual block identifiers of the blocks 505 form a global block address space in which each of the virtual block identifiers is unique.

The shared storage network system 500 further comprises a first storage client 506 and a second storage client 507 each functioning as storage consuming nodes.

The storage servers 501, 502 and the storage clients 506, 507 are grouped into first to third local area networks 508 to 510 interconnected to form a global optical network 511.

Each of the storage clients 506, 507 is adapted to have read and write access to each block 505 of each of the storage portions 503. Particularly, the storage clients 506, 507 have access to storage provided by storage portions 503 related to a LAN 508 to 510 which is located remote (i.e. associated to a remote LAN) from the demanding storage client 506, 507.

Thus, if one of the storage clients 506, 507 needs some storage resource, this storage client 506, 507 can access the storage provided by the storage servers 501, 502, i.e. can write data to the storage of the storage servers 501, 502 and can read the information from there.

The first to third local area networks 508 to 510 are interconnected such that in case of a read or a write access of one of the storage clients 506, 507 to at least one of the blocks 505, the virtual block address of a block 505 to which access is desired is translated into a physical block address to identify the physical block associated with the virtual block.

The first local area network 508 comprises a first linking computer 512 being interconnected as a link between the first storage server 501 of the first local area network 508 associated with the first linking computer 512 on the one hand and the remaining local area networks 509, 510 on the other hand. In a similar manner, the third local area network 510 comprises a second linking computer 513 being interconnected as a link between the second storage client 507 of the third local area network 510 associated with the second linking computer 513 on the one hand and the remaining local area networks 508, 509 on the other hand.

Each of the linking computers 512, 513 are adapted to perform the translation of a virtual block address of a block 505 to which access is desired into the physical block address of this block 505.

In the following, a scenario is described in which the first storage client 506 desires to use the storage portion 503 of the first storage server 501 to store data there. For this purpose, the first storage client 506 sends a write request to the first storage server 501.

Before a burst transmission from the first storage client 506 to the first storage server 501 is carried out, a control device of the shared storage network system 500 determines a proper length of such a burst and accumulates data related to the write request until the amount of data equals the determined length of the burst. The length of the burst to be transmitted according to the write access is determined based on a parameter indicating an available buffer size of the first storage server 501, and based on a predetermined timeout value parameter indicating a time after which improper burst transmission is assumed to have been occurred in the optical network 511.

After having determined the burst length, data is accumulated according to this burst length and subsequently, resources of the optical network 511 are reserved such that the accumulated data can be transmitted via the optical network 511 from the first storage client 506 to the first storage server 501.

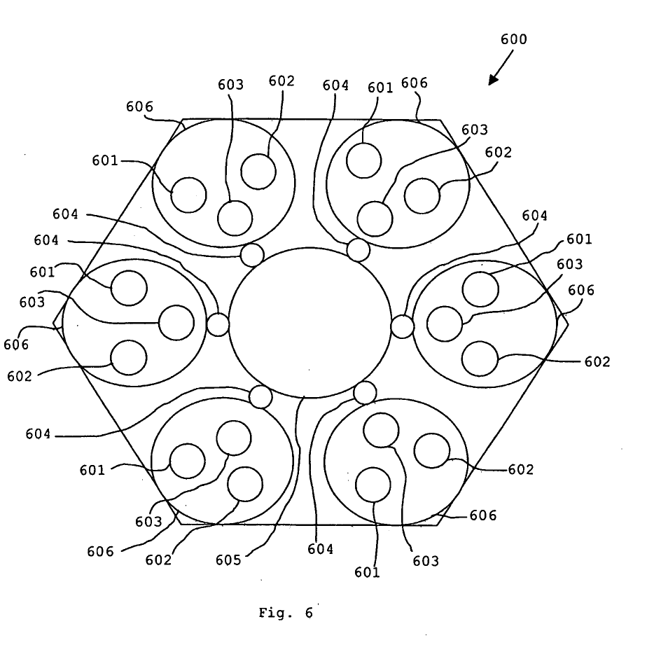

Referring to FIG. 6, a shared storage network system 600 according to another preferred embodiment of the invention will be explained.

Compared to the shared storage network system 500 shown in FIG. 5, the shared storage network system 600 shown in FIG. 6 is more symmetrical. The shared storage network system 600 is constituted by a plurality of local area networks 606 interconnected by an optical domain network 605. Each local area network 606 comprises a first storage server 601 and a second storage server 602 as storage providing nodes, and a storage client 603 as a storage consuming node. The link between nodes 601 to 603 of each LAN 606 and the optical domain 605 is performed by a linking computer 604 associated to each LAN 606.

In the following, an overview of the functionality of embodiments of the system of the invention will be given.

First, the system architecture of the shared storage network system of the invention is described.

The network system of the invention is designed as a solution to the layer II (block layer) of the four-layer SNIA shared storage model, as discussed referring to FIG. 4 and as disclosed in [3], with the optical networks as the interconnection networks. An aspect of the system of the invention is to provide a huge storage with a single global block address space over optical networks. As the system scale increases, it is able to provide nearly unlimited storage space and I/O speed at reasonable cost.

The shared storage network system 500, 600, also denoted as globally addressable storage system is designed as a large scale distributed shared storage system with the optical networks as the interconnection networks.

In this system, each node (storage server, storage client, linking computer) can communicate with each other through both a data channel, which will be the optical links and a communication channel, which could be a low data rate channel, e.g. Ethernet or a dedicated optical channel as shown in FIG. 6. The whole system acts as a huge storage with a single block address space since each block in the system is globally identified by a global block address. The system is described below with reference to FIG. 5, FIG. 6.

Based on the functionality difference, nodes of the system can be classified into three categories: storage server, storage clients, linking computers (the latter also denoted as block address translation server, BATS). A storage server node is a node to provide storage resource to the system, e.g. a storage server from a Storage Area Network (SAN). A storage client node is a node to consume storage resource from the system, e.g. a computer host. It is possible for a node to act as both storage server and storage client to consume some storage from the system while also serving some storage to others.

In additional to the server and client nodes, the BATS node is optionally implemented in the system. One of the basic assumptions of the system is that optical connections are available between the client and server nodes as data channel for very high performance I/O data transfer. The data transfer can be directly established between the client and server. However, this assumes that every node has a direct interface connection to the optical domain. A BATS node could be installed in a LAN as the edge node to the optical domain, e.g., a edge router. In this case, BATS acts as an access point to the optical domain and its optical link could be shared by those nodes in its local area. Since the communication between a BATS and other nodes within the same LAN is local area communication, a BATS node could natively extend any local oriented storage transmission protocol, e.g. Fiber-Channel protocol, to wide area.

In the following, an optical burst flow control method will be described which is important for the invention.

In order to efficiently utilize the huge bandwidth in the optical domain, an optical burst flow control (OBFC) method is applied. Major components of this scheme comprise a dynamic burst assembly mechanism and a burst reservation and transmission method. As in the burst reservation and transmission method, a random burst eligibility time method is used according to a first preferred embodiment, and a time domain division method is used according to a second embodiment.

Based on the parameters contained in the I/O requests, the dynamic burst assembly mechanism prepares the optical burst with a proper length by accumulating the I/O traffic to increase the network utilization, but not against the application requirements. After the length of the optical burst for current I/O request is decided, the random burst eligibility time method, which is suitable for implementation in bufferless WDM networks, provide an efficient way for data transmission using optical burst switch. It provides service differentiation in terns of response time and burst loss probability.

The pre-decision of the optical burst length for each I/O request makes the arrival and departure time of such burst at all the intermediate optical nodes predictable. Therefore, with the dynamic burst assembly mechanism, all the wavelength switch at the intermediate optical node could be mapped to the time domain. The optional data transmission method denoted as the time domain division method makes use of such ability to map the bursts to the fine-grain time slices to improve the utilization further over the optical domain by reducing the setup overhead.

In the following, the optical burst switching (OBS) network architecture will be described.

The optical burst switching network is used in the system of the invention as the interconnection network. At the ingress node, edge routers determine the data burst-size and the offset time after considering I/O request requirement. Control packets, which contain information including the egress address, offset time, data burst size, and quality of service (QoS), go ahead on the communication channel, which can be on separate control wavelengths or Ethernet, and the main data burst follows the control packet after a given offset time. These control packets are converted to electrical signals for processing at every intermediate node.

At the core node, bandwidth is reserved for the transmission time of the data burst. The elements that need to be monitored in traffic engineering are blocking probabilities, latency, and processing time. This information determines the optical path at the ingress node. At the egress node, a data burst is de-framed and disassembled into multiple IP (internet protocol) packets in a rather simple manner. Burst reordering and retransmission handled in parameters, such as offset time, burst size, and QoS values, are essential in achieving an OBS network. These are assigned in the ingress node of the OBS networks.

Next, a dynamic burst assembly mechanism according to the invention is described.

The system of the invention is designed as a solution implemented in layer II (block layer) of the SNIA shared storage model. An ACK (acknowledgement) mechanism, called optical burst mode flow control (OBFC) scheme, has been adopted to support flow control of data between a storage client and storage server pair. The ACK window size refers to the number of packets that the transmitter may continuously send before waiting for an acknowledgement. This window size must be negotiated and agreed upon before data flow can take place. Such optical burst flow control scheme is proposed to accumulate the traffic to be the burst before travelling through the optical domain.

In the following, a plurality of parameters introduced in the dynamic burst assembly mechanism are defined:

u: peak service rate at the storage client,

R: round trip time including the data transmission time in optical domain and the ACK through the communication channel,

CWᵢₙᵢₜ: initial window size

B: reserved buffer size at the storage client

T: timeout value before sending NAK (negative acknowledgement) in terms of round trip time, e.g. T=β×R

P: assuming the fixed size for the data packet,

L_{burst}: eligibility length of burst prepared for transmission

The OBFC ACK window size, which is the number of packets that the transmitter may continuously send before waiting for an acknowledgement, could be negotiated. L_{burst} is the eligibility length of a burst prepared for transmission at the storage server and L_{burst}/P is the OBFC ACK window size. The minimum OBFC ACK window size to meet client requested rate is defined by:

CWᵢₙᵢₜ/R≧u [symbol] CWᵢₙᵢₜ≧R×u (1)

Therefore, the border case is defined by:

CWᵢₙᵢₜ=R×u (2)

In order to increase the utilization of optical domain, the optical burst length L_{burst} should be accumulated as large as possible but it should meet the application deadline and not exceed the buffer available at the client side.

Let

B=α×P×CWᵢₙᵢₜ (3)

and

T=β×R (4)

In equations (3), (4), α is a parameter indicating an available buffer size of the destination computer, and β is a predetermined timeout value parameter indicating a time after which improper burst transmission is assumed to have been occurred.

Then

L_{burst}=Min[α,β]×P×CWᵢₙᵢₜ=Min[α,β]×P×R×u (5)

The scheme mentioned above appears just for read operation issued by storage client to fetch the data from the remote storage server. However, it can be seen from FIG. 6 that all the storage client/server nodes are at the symmetrical network position. It is clear that the exactly same scheme can be used for all kinds of storage I/O operation in the shared storage network system. When a BATS node is implemented, bursts can be prepared at the corresponding local BATS node before entering the optical domain.

In the following, the random burst eligibility time method will explained in detail.

The random burst eligibility time method is a basic burst reservation and transmission method in the proposed OBFC method. In optical domain, the bandwidth is so huge that it can even be considered as unlimited with sufficient accuracy. The response time becomes a more important QoS parameter.

Next, a plurality of parameters introduced in the random burst eligibility time method are defined:

p: control packet process time at each intermediate optical node

δ: propagation delay of the reservation to each intermediate optical node

H: Number of hops

θ: Light path setup delay

The parameters are linked as follows:

θ=(p+δ)×H (6)

Once the client I/O request is granted, the burst starts to be prepared and the server will randomly pickup a time τ within the interval [min(θ, L_{burst}_{_{—}}ₘᵢₙ/(P×u)), L_{burst}/(P×u)] as the eligibility time for the burst transmission. A control packet containing the random burst eligibility time is sent out through the communication channel to perform the resource reservation once such burst eligibility time is chosen. In this scheme, the random eligibility time τ will be used as both the edge delay for burst preparation and the offset time introduced in [4] between the control packet and the data burst. Here, L_{burst}_{_{—}}ₘᵢₙ is the minimal eligibility length of burst prepared for transmission. No explicit definition to the minimum size of the data burst has to be given, which could be introduced by the protocols adopted in the other layers.

Particularly if the random burst eligibility time, which is also the offset time between the control packet and the data burst, is greater or equal to twice the light path setup delay, a reservation confirmation packet becomes possible. The time range used to pick up the eligibility time is roughly equal to the application tolerable end-to-end delay, e.g. the tolerable end-to-end delay of delay sensitive Voice over Internet Protocol (VoIP) traffic is around 150 ms. Assuming the maximum number of hops H is 5, the control packet processing time p is 1 ms, and a propagation delay of 3 ms for an OBS network diameter of 600 km, these assumptions yield an light path setup delay of 8 ms. Since the eligibility time τ is randomly pickup from a relatively wide time range comparing to the light path setup delay, it is most likely to have sufficient time to allow a reservation confirmation packet back.

In order to make reservation confirmation possible in the sufficient offset case, the control message will record the latest reserved time at each intermediate node along the traversed path. Once a reservation fails, the latest reserved time recorded in the control packet will be sent back in the confirmation message, if the current time plus the time for confirmation to travel back is not later than the eligibility time indicated in the control packet. The confirmation packet will release the resource at each intermediate node along the way and perform the new reservation. The burst prepared during the postponed period should be included in the new reservation. Normally, the ingress node will not expect a reservation confirmation packet. A confirmation packet will indicate the resource reservation failure using the random burst eligibility time and the latest reserved time recorded in the confirmation packet will be used as the new burst eligibility time.

By the random burst eligibility time method, high priority request more likely get shorter response time. Since the burst length is proportional to the edge delay τ, higher priority request allows shorter burst that is discarded with a lower probability. Low priority request get slower response but during waiting large traffic could be accumulated. Once the chance is performed, network utilization could be increased. The random burst eligibility time allows a resource reservation confirmation packet which can lower the burst drop probability.

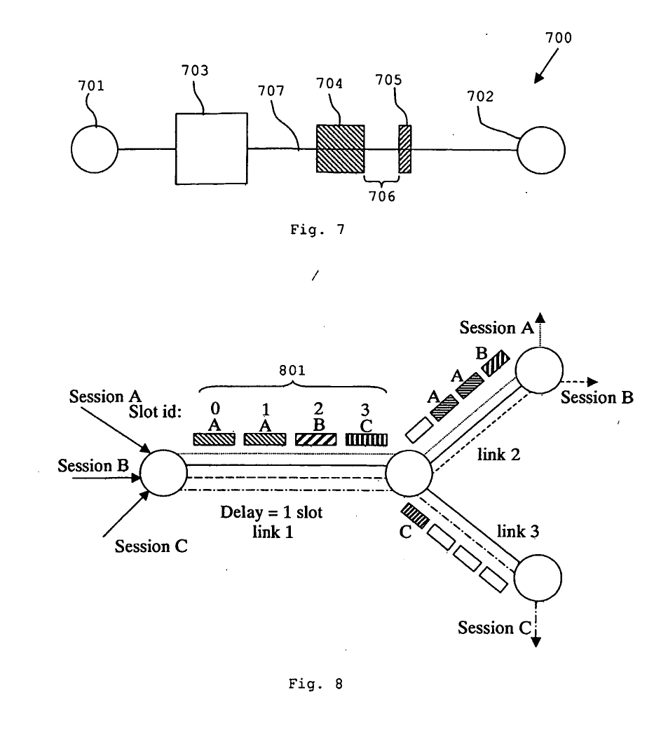

Referring to FIG. 7, a data path 700 illustrating the transmission of a burst according to a preferred embodiment of the invention will be described, in which a control packet followed by a burst is used for transmitting data.

As shown schematically in FIG. 7, data is to be transmitted from a source computer 701 (e.g. a storage server during a read access of a storage client) to a destination computer 702 (e.g. the storage client during the read access). A control device 703 of the invention is provided controlling the transmission of a burst 704, i.e. data to be transmitted, along an optical path 707. The burst is preceded by a control packet 705 which is sent shifted with respect to the burst 704 by an offset time 706.

According to the architecture shown in FIG. 7, the control device first determines the length of a burst 704 to be transmitted. Then, data to be transmitted is accumulated until the size of this accumulated data equals the determined length of the burst 704. Then, network resources required for transmitting burst 704 over the optical network 707 is reserved. After that, the control packet 705 containing control information (e.g. size of the burst 704, etc.) is transmitted, followed by the transmission of the burst 704 after the offset time 706. Then, the data to be transferred is received by the destination computer 702 where the data may be stored.

In the following, the time domain division method will explained in detail.

With the dynamic burst assembly mechanism, the random burst eligibility time method can greatly improve the utilization in an optical domain. However, some bandwidth may be wasted during the resource reservation period for each burst. Since it may be too costly to wait for the confirmation of the resource reservation request, there still exists the possibility of the resource reservation failure along the light-path, which will result in the burst dropping in the intermediate optical node.

FIG. 8 shows a data path 800 illustrating the transmission of a burst according to another preferred embodiment of the invention, in which the time domain division method of the invention is included.

In order to eliminate the burst transmission setup delay and the possibility of burst dropping at intermediate node, the time domain division method may be designed over the WDM network. In the time domain division method, the divided wavelength is further divided along the time domain into a series of time slots 801 of fixed length τ, which is the minimum duration of reservation. Such a dynamic routing and wavelength allocation (RWA) method used to establish a light path for the transmission of the burst can be fulfilled by either a centralized or distributed wavelength assignment control. The former option is preferred according to the invention. The feasibility of the RWA on TDM has been proven in [2]. Based on a reservation request, an integer number of time slots will be assigned to the traffic source and such time domain reservation will be setup at all links along the path 800. Here, all the links characteristics should be understood by all the intermediate optical nodes, e.g. the link propagation and node procession delay, which will be used for calculating the shift of all allocated slots along the path. By this time domain division method, reservation could be done per I/O request.

In order to make the time domain division possible, the arrival and departure time of each variable-size burst should be predictable. It could be solved by the optical burst-shaping scheme. Once the u and L_{Burst} are decided, the time and duration of each burst transmission are predictable. After it reserves the time slot for each burst duration, the traffic source could just send out the data upon its turns. If the source transmitting rate falls below u, some reserved slots will be empty. However, such over-reservation situation will be avoided on the next I/O request.

The time domain division method is defined as a reservation and burst transmission method in the proposed OBFC method. It could operate independently (alternatively) and also could co-exist with random burst eligibility time method based on the traffic QoS requirement. A description on such coexistence concept is disclosed in [1].

In this specification, the following documents are cited:
[1] Q. Qiu, L. Jacob, R. R. Pillai, and B. Prabhakaran. “MAC Protocol Enhancements for QoS Guarantee and Fairness over the IEEE 802.11 Wireless LANS”, Proceedings of the IEEE ICCCN 2002, 2002
[2] B. Wen, K. M. Sivalingam, “Routing, wavelength and time-slot assignment in time division multiplexed wavelength-routed optical WDM networks”, IEEE INFOCOM 2002, vol. 3, pp. 1442-1450
[3] SNIA Technical Council, “Shared Storage Model”, SNIA TC Proposal Document, 2001
[4] C. Qiao and M. Yoo, “Optical burst switching (OBS)—A new paradigm for an optical Internet” J. High Speed Networks, vol. 8, no. 1, pp. 69-84, 1999
[5] J. Y. Wei and R. I. McFarland “Just-in-time signaling for WDM optical burst switching networks” J. Lightwave Tech., vol. 18, no. 12, pp. 2019-2037, 2000
[6] Gail C. Hudek and Douglas J. Muder, “Signaling Analysis for a Multi-Switch All-Optical Network,” IEEE, Int'l Conf. in Communications, vol. 2, pp. 1206-1210, 1995
[7] J. S. Turner, “Terabit burst switching” J. of High Speed Networks, vol. 8, no. 1. pp. 3-16, 1999
[8] K. Dolzer, C. Gauger, J. Spath, and S. Bodamer, “Evaluation of reservation mechanisms for optical burst switching” AE International Journal of Electronics and Communications, vol. 55, no. 1, 2001.
[9] Y. Xiong, M. Vandenhoute, and H. C. Cankaya, “Control architecture in optical burst-switched WDM networks”, IEEE Journal on Selected Areas in Communications, vol. 18, no. 10, pp. 1838-1851, 2000
[10] M. Yang, S. Q. Zheng, and D. Verchere, “A QoS supporting scheduling algorithm for optical burst switching DWDM networks”, IEEE Globecom, pp. 86-91, 2001
[11] M. Yoo, C. Qiao, and S. Dixit, “QoS performance of optical burst switching in IP-over-WDM networks”, IEEE JSAC, vol. 18, no. 10, pp. 2062-2071, 2000
[12] K. Dolzer and C. Gauger, “On burst assembly in optical burst switching networks—a performance evaluation of Just-Enough-Time”, ITC-17, pp. 149-161, 2001

### REFERENCE SIGNS

100 optical burst switch system

101 data input

102 data output

103 switch matrix

104 input module

105 control packet routing unit

106 buffer and schedule unit

107 output module

200 diagram

201 abscissa

202 ordinate

203 burst

204 control packet

205 source node

206 destination node

207 intermediate nodes

208 offset time

300 time diagram

301 time axis

302 case 1

303 case 2

400 SNIA layer model

401 layer I

402 layer II

403 layer III

404 layer IV

500 shared storage network system

501 first storage server

502 second storage server

503 storage portion

504 sectors

505 blocks

506 first storage client

507 second storage client

508 first local area network

509 second local area network

510 third local area network

511 optical network

512 first linking computer

513 second linking computer

600 shared storage network system

601 first storage server

602 second storage server

603 storage client

604 linking computer

605 optical domain network

606 local area network

700 data path

701 source computer

702 destination computer

703 controlling device

704 burst

705 control packet

706 offset time

707 optical path

800 data path

801 time slots

1. A control device for controlling the optical data transmission in optical burst switching mode between a source computer and a destination computer, the control device being
connected to the source computer and to the destination computer;
adapted such that in case of a burst to be transmitted from the source computer to the destination computer, the length of the burst is determined based on
a parameter indicating an available buffer size of the destination computer; and
a predetermined timeout value parameter indicating a time after which improper burst transmission is assumed to have occurred.

2. The control device according to claim 1, which is adapted such that the length of the burst is determined further based on an initial window size indicating a number of data packets which the source computer is able to send before waiting for an acknowledgement.

3. The control device according to claim 1, which is adapted such that the length of the burst is determined further based on a packet size indicating the size of data packets which the source computer is able to send.

4. The control device according to claim 1, which is adapted such that the length of the burst is determined further based on a round trip time of the burst transmission.

5. The control device according to claim 1, which is adapted such that the length of the burst is determined further based on a peak service rate which the destination computer is able to service.

6. The control device according to claim 1, which is adapted such that the length of the burst is determined in dependence of a minimum of the parameter indicating an available buffer size of the destination computer and of the predetermined timeout value parameter indicating a time after which improper burst transmission is assumed to have occurred.

7. The control device according to claim 1, which is adapted such that data to be transmitted is accumulated in the source computer until the size of the data to be transmitted generally equals the determined length of the burst to be transmitted.

8. The control device according to claim 1, which is adapted such that, based on the determined length of the burst to be transmitted, resources for transmitting the burst are reserved and the burst is transmitted.

9. The control device according to claim 8, which is adapted such that the reservation and transmission is realized using an optical burst switch network.

10. The control device according to claim 9, which is adapted such that the optical burst switch network comprises means for sending a control packet followed by the burst after a predetermined offset time.

11. The control device according to claim 9, which is adapted such that the optical burst switch network comprises means for sending a reservation confirmation packet indicating that reservation has been performed.

12. The control device according to claim 8, which is adapted such that the reservation and transmission is realized by dividing, in the time domain, a burst to be transmitted into a plurality of burst slices.

13. The control device according to claim 1, which is adapted such that, in case of a predetermined data path for transmission of the burst, at least one intermediate computer located in the data path between the source computer and the destination computer is implemented as a cache storage computer for temporarily storing data related to the transmitted burst.

14. The control device according to claim 1, which is adapted such that once the length of the burst is determined, a burst reservation and transmission is performed based on a random burst eligibility time method, to deliver the optical burst.

15. The control device according to claim 14, which is adapted such that a time between the time to prepare a minimum burst and the time to prepare a full pre-determined burst is randomly picked up as a burst eligibility time.

16. A shared storage network system, comprising a control device according to claim 2 for controlling the optical data transmission in an optical burst switching mode between one of at least one storage server each providing a storage portion to the shared storage network system and one of at least one storage client adapted to have read and/or write access to at least one storage portion of at least one of the at least one storage server, the storage server and the storage client being the source computer and the destination computer.

17. The shared storage network system according to claim 16, wherein
the at least one storage server is located within a first local area network;
the at least one storage client is located within a second local area network, the first local area network and the second local area network being interconnected to form a global network;
the at least one storage server and the at least one storage client are interconnected such that in case of a read or a write access of one of the at least one storage client to one of the at least one storage server, the length of a burst to be transmitted according to the read or write access is determined based on
the parameter indicating an available buffer size of the storage server or the storage client, which storage server or storage client is the destination computer of the burst transmission associated with the read or write access; and
the predetermined timeout value parameter indicating a time after which improper burst transmission is assumed to have occurred.

18. The shared storage network system according to claim 17, wherein the first local area network further comprises at least one of said at least storage client and/or the second local area network further comprises at least one of the at least one storage server.

19. The shared storage network system according to claim 17, comprising at least one further local area network comprising at least one storage server and/or at least one storage client, the at least one further local area network being interconnected to the global network.

20. The shared storage network system according to claim 19, wherein at least one of the local area networks comprises a linking computer being interconnected as a link between the at least one storage server and/or the at least one storage client of the local area network associated with the linking computer on the one hand and the remaining local area network or networks on the other hand.

21. The shared storage network system according to claim 19, wherein at least one of the local area networks is an optical network or a wired network.

22. The shared storage network system according to claim 16, which is adapted to operate based on the Storage Networking Industry Association standard.

23. The shared storage network system according claim 22, which is adapted to operate on the second layer of the Storage Networking Industry Association standard.

24. The shared storage network system according to claim 16, which is adapted such that the entirety of all of the storage portions of the at least one storage server form a global block address space.

25. A method for controlling the optical data transmission in an optical burst switching mode between a source computer and a destination computer, comprising the steps of
connecting the source computer to the destination computer;
in case of a burst to be transmitted from the source computer to the destination computer, determining the length of the burst based on
a parameter indicating an available buffer size of the destination computer; and
a predetermined timeout value parameter indicating a time after which improper burst transmission is assumed to have occurred.
